(19) United States
(12) Patent Application Publication
(10) Pub. No.: US 2026/0058083 A1
(43) Pub. Date: Feb. 26, 2026

(54) FUSIBLE LINK UNIT AND ELECTRIC JUNCTION BOX

(71) Applicant: YazakiCorporation, Tokyo (JP)

(72) Inventors: Makoto Yamaguchi, Makinhara-shi (JP); Kai Odahima, Makinohaara-shi (JP)

(21) Appl. No.: 19/303,993

(22) Filed: Aug. 19, 2025

(30) Foreign Application Priority Data
Aug. 26, 2024 (JP) 2024-144355

(51) Int. Cl. H01H 85/11; H01H 85/055; H01H 85/143; H01H 85/175

(52) U.S. Cl. CPC H01H 85/11; H01H 85/143; H01H 85/1755; H01H 2085/0555

(57) ABSTRACT

A fusible link unit includes a conductor having a fuse function, and a housing that accommodates the conductor. The conductor includes an input terminal that inputs electric power from a power source, an output terminal that outputs the electric power, a fusing portion disposed on an energization path from the input terminal to the output terminal, and a relief terminal portion capable of connecting a relief tool for supplying the electric power to the power source from outside. The input terminal and the relief terminal portion are provided on a continuous exposed piece of the conductor exposed from the housing.

### CROSS-REFERENCE TO RELATED APPLICATIONS

This application is based on and claims priority under 35 USC 119 from Japanese Patent Application No. 2024-144355 filed on Aug. 26, 2024, the contents of which are incorporated herein by reference.

### TECHNICAL FIELD

The present disclosure relates to a fusible link unit and an electric junction box using the fusible link unit.

### BACKGROUND ART

In the related art, a fusible link unit has been proposed, in which a bus bar having a fusing portion that fuses at a predetermined current value is embedded in a resin housing (for example, see Patent Literature 1).

### CITATION LIST

### Patent Literature

Patent Literature 1: JP2021-166160A

### SUMMARY OF INVENTION

Incidentally, in a situation where a charge amount of a battery mounted on a vehicle such as an automobile is extremely reduced, electric power may be supplied to the battery from the outside of the vehicle (for example, another relief vehicle). A relief terminal for connecting a relief tool (for example, a clip of a booster cable) used for power supply from the outside may be provided in an electric junction box of a vehicle. However, when a dedicated bus bar or the like used as a relief terminal is provided in the electric junction box, such a bus bar may hinder miniaturization of the electric junction box. It may be difficult to provide such a dedicated bus bar or the like at a desired position depending on a size of a surplus space of the electric junction box.

An object of the present disclosure is to provide a fusible link unit and an electric junction box capable of reducing a size of the electric junction box while providing a relief terminal in the electric junction box.

In order to achieve the above-described object, a fusible link unit and an electric junction box according to the present disclosure are characterized as follows.

A fusible link unit of the present disclosure includes a conductor having a fuse function, and a housing that accommodates the conductor. The conductor includes an input terminal that inputs electric power from a power source, an output terminal that outputs the electric power, a fusing portion disposed on an energization path from the input terminal to the output terminal, and a relief terminal portion capable of connecting a relief tool for supplying the electric power to the power source from outside. The input terminal and the relief terminal portion are provided on a continuous exposed piece of the conductor exposed from the housing.

An electric junction box of the present disclosure includes the fusible link unit described above and a case having an accommodation space in which the fusible link unit is accommodated.

According to the fusible link unit and the electric junction box of the present disclosure, a part of a conductor (for example, a bus bar) having a fuse function is used as a relief terminal portion to which a relief tool can be connected. In other words, the fusible link unit has a function as a relief terminal in addition to its original overcurrent interruption function. Therefore, it is not necessary to provide a dedicated bus bar or the like used as the relief terminal portion in the electric junction box. Therefore, in the fusible link unit and the electric junction box of the present disclosure, it is possible to reduce the size of the electric junction box while providing the relief terminal in the electric junction box.

Furthermore, as another effect, in the fusible link unit and the electric junction box of the present disclosure, the relief terminal portion and the input terminal are commonly provided on a continuous exposed piece of the conductor exposed from the housing. In general, an input terminal that inputs electric power from a power source such as an in-vehicle battery to the fusible link unit is disposed at a peripheral edge of the electric junction box in terms of the operability of work of connecting a power cable. Therefore, when the fusible link unit is attached to the electric junction box, the relief terminal portion is also disposed on the peripheral edge of the electric junction box. Therefore, as compared with a case where the relief terminal portion is disposed at the center of the electric junction box or the like, the operability of a user when a relief operation is actually performed can be improved.

The present disclosure has been briefly described above. Further, details of the present disclosure will be clarified by reading modes for carrying out the invention described below with reference to the accompanying drawings.

### BRIEF DESCRIPTION OF DRAWINGS

FIG. 1 is a perspective view of a fusible link unit according to an embodiment of the present disclosure;

FIG. 2 is a side view of the fusible link unit shown in FIG. 1;

FIG. 3 is a perspective view of the fusible link unit shown in FIG. 1 with a cover removed from a housing;

FIG. 4 is a plan view of a bus bar constituting a fuse element shown in FIG. 1;

FIG. 5 is a perspective view of an electric junction box in which the fusible link unit shown in FIG. 1 is accommodated;

FIG. 6 is a plan view of the electric junction box shown in FIG. 5;

FIG. 7 is a perspective view showing a state where a clip of a booster cable is connected to a relief terminal portion exposed to an outside in the electric junction box shown in FIG. 5; and

FIG. 8 is an enlarged view showing a part of a fusible link unit according to another embodiment.

### DESCRIPTION OF EMBODIMENTS

### Embodiments

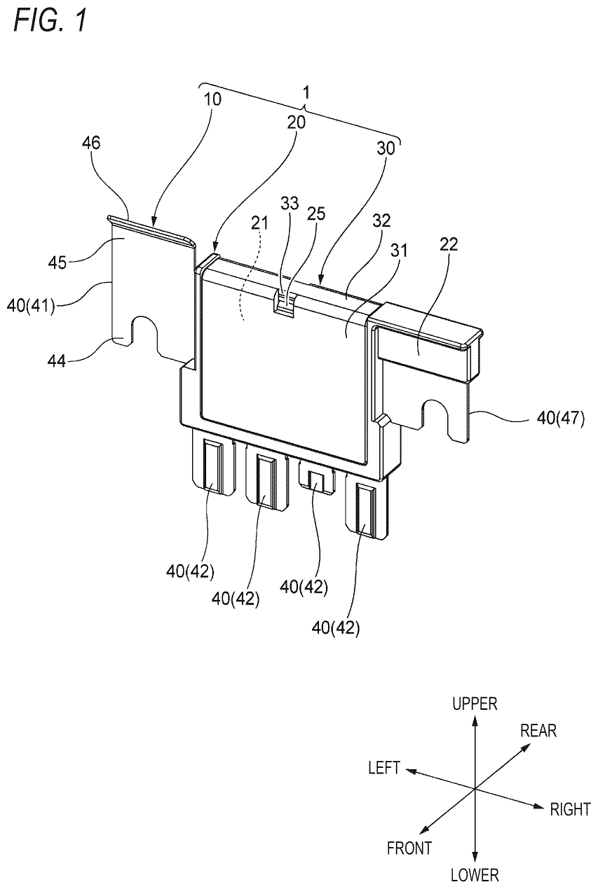

Hereinafter, a fusible link unit 1 according to an embodiment of the present disclosure will be described with reference to the drawings. The fusible link unit 1 has a function of electrically connecting a battery (not shown) connected to an input terminal 44 (see FIG. 1 and the like), external loads (not shown) connected to output terminals 42 (see FIG. 1), and a DC/DC converter (not shown) connected to another input terminal 47, and disconnecting the battery from the external loads and the DC/DC converter when a current having a magnitude exceeding a rated current flows.

Hereinafter, for convenience of description, a “front-rear direction”, a “left-right direction”, and an “upper-lower direction”, “front”, “rear”, “left”, “right”, “upper”, “lower” are defined as shown in FIG. 1. The “front-rear direction”, the “left-right direction”, and the “upper-lower direction” are orthogonal to one another. These directions are merely defined for the convenience of description, and do not necessarily correspond to, for example, the front-rear direction, the left-right direction, and the upper-lower direction of the automobile or the like when the fusible link unit 1 is mounted on the automobile or the like.

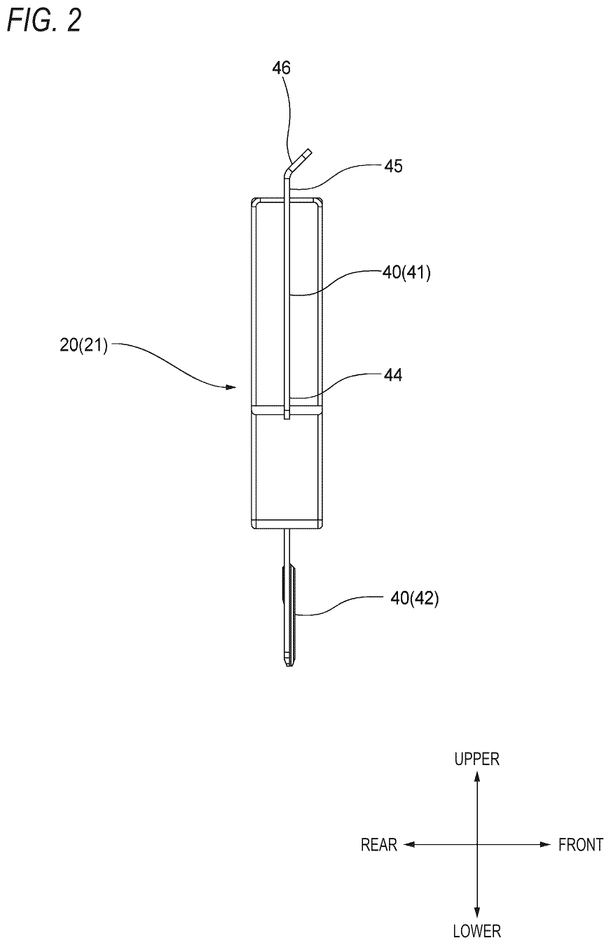

As shown in FIGS. 1 to 3, the fusible link unit 1 includes a fuse element 10, a housing 20, and a cover 30 attached to the housing 20. As can be understood from FIG. 2, each of the housing 20 and the cover 30 has a shape that is plane-symmetrical with respect to a plane (a symmetry plane) passing through the center in the front-rear direction and perpendicular to the front-rear direction. Hereinafter, the members constituting the fusible link unit 1 will be described in order.

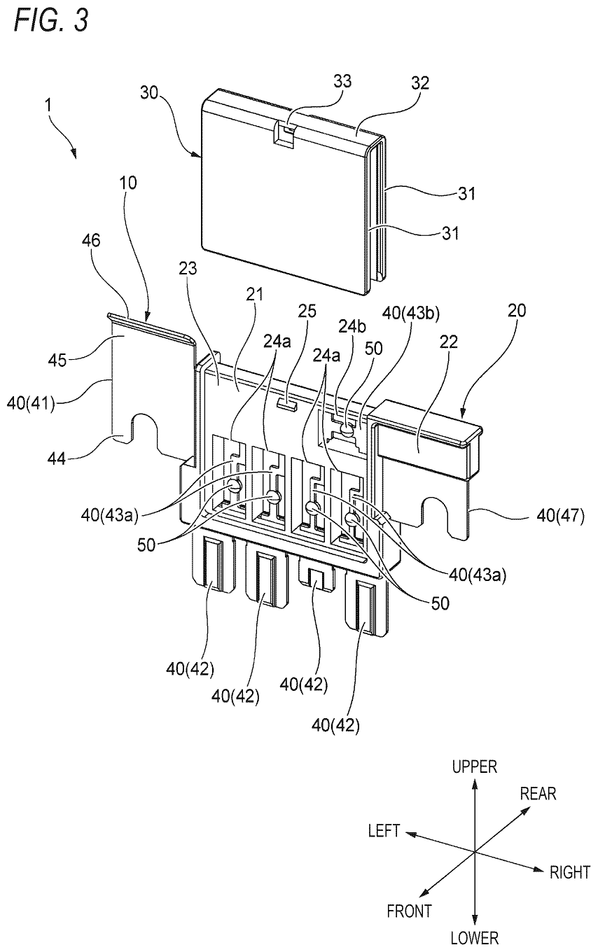

First, the housing 20 will be described. The housing 20 is a resin molded body formed of a resin material integrally with the fuse element 10 (insert molding) to cover (embed) most of the fuse element 10. As can be understood from FIGS. 1 to 3 (particularly, FIG. 3), the housing 20 generally includes a substantially rectangular parallelepiped housing body 21 extending in the left-right direction and the upper-lower direction, and a substantially rectangular parallelepiped housing protruding portion 22 protruding rightward from an upper right corner of the housing body 21.

Substantially rectangular cover accommodating recess 23 for accommodating a pair of side wall portions 31 (to be described later) of the cover 30 are respectively formed in front and rear end surfaces of the housing body 21 so as to be recessed in a thickness direction (the front-rear direction) of the housing body 21.

In each of the substantially rectangular bottom surfaces of the pair of front and rear cover accommodating recesses 23 of the housing body 21, a plurality of (four in this example) openings 24a are defined and formed to be aligned in the left-right direction in a lower region thereof, and a single opening 24b is formed at an upper right end thereof. Each of the openings 24a and the opening 24b is a rectangular hole penetrating in the front-rear direction to communicate the bottom surfaces of the pair of front and rear cover accommodating recesses 23 with each other. Hereinafter, when it is not necessary to distinguish the opening 24a and the opening 24b, each of the opening 24a and the opening 24b may be referred to as an “opening 24”.

Each of the substantially rectangular bottom surfaces of the pair of front and rear cover accommodating recesses 23 of the housing body 21 is formed with a locking projection 25 at a central portion in the left-right direction of an upper end thereof. In a state where the cover 30 is attached to the housing 20, a pair of front and rear locking holes 33 (to be described later) of the cover 30 are engaged with the pair of front and rear locking projections 25 (see FIG. 1).

Next, the fuse element 10 will be described. As shown in FIG. 3, the fuse element 10 includes a bus bar 40 (a flat plate-shaped metal member), and a plurality of (in this example, five) low-melting bodies 50 disposed in a plurality of (in this example, four) fusing portions 43a and a single fusing portion 43b, which are parts of the bus bar 40.

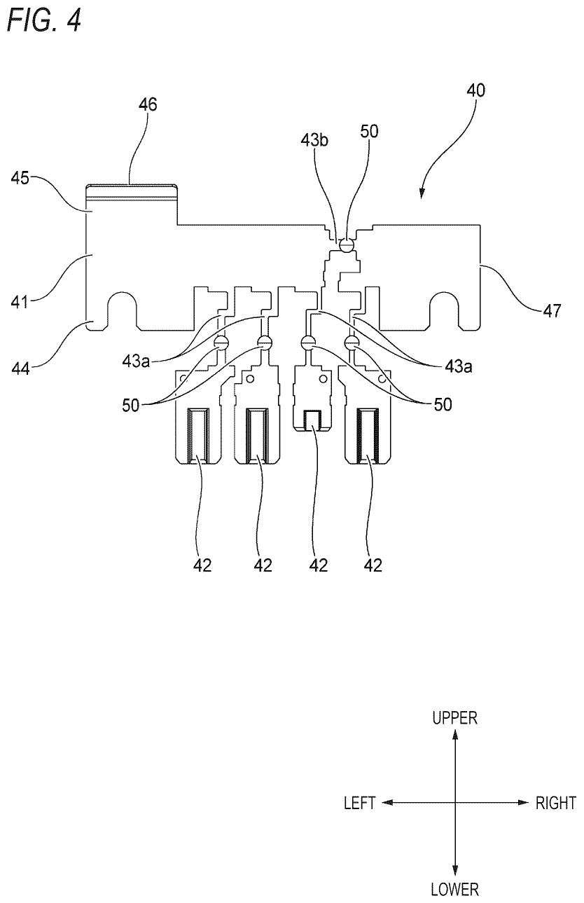

As shown in FIG. 4, the bus bar 40 has a flat plate shape extending in the left-right direction and the upper-lower direction, and a plate thickness (a length in the front-rear direction) of the bus bar 40 is constant over the entire region in this example. Most of the bus bar 40 is embedded in the housing 20 (the housing body 21+ the housing protruding portion 22) to extend along the symmetry plane including the symmetry plane of the housing 20 (see FIG. 3).

As shown in FIG. 3, the bus bar 40 includes a connection portion 41, the plurality of (four in this example) output terminals 42, the input terminal 47, the plurality of (four in this example) fusing portions 43a, and the single fusing portion 43b as portions exposed to an outside from the housing 20 (the housing body 21 +the housing protruding portion 22). Hereinafter, when it is not necessary to distinguish the fusing portion 43a and the fusing portion 43b, each of the fusing portion 43a and the fusing portion 43b may be referred to as a “fusing portion 43”.

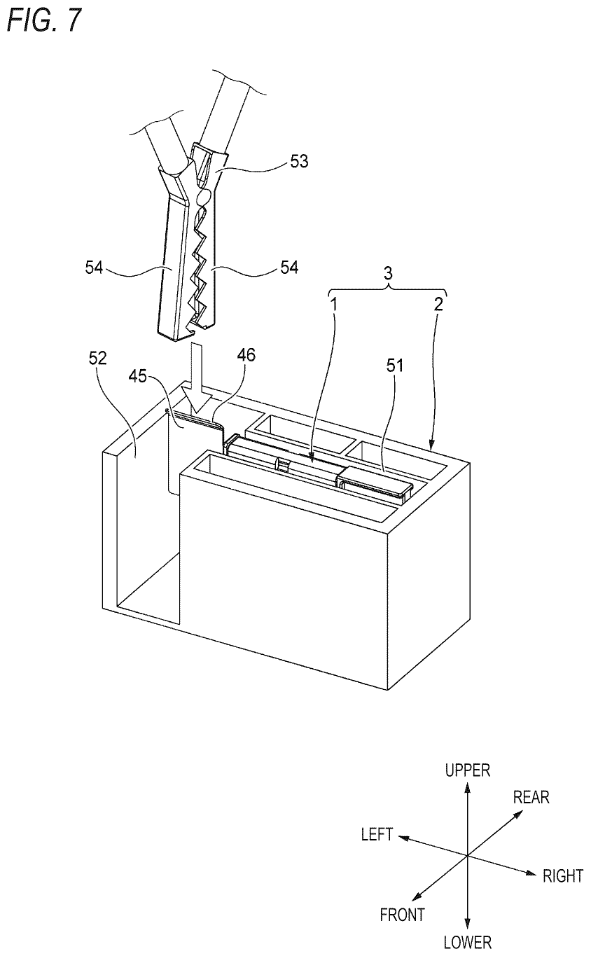

The connection portion 41 is a substantially rectangular flat plate-shaped portion protruding leftward from a left end surface of the housing body 21 of the housing 20 and extending in the upper-lower direction. A lower region of the connection portion 41 functions as the input terminal 44, and an upper region of the connection portion 41 (in particular, a portion protruding upward from an upper end of the housing 20) functions as the relief terminal portion 45. The relief terminal portion 45 has a shape separated upward from the housing 20. A battery terminal (not shown) connected to a battery post of a vehicle battery is connected to the input terminal 44. A clip 53 (see FIG. 7) of a booster cable is connected to the relief terminal portion 45. A curved portion 46 that is curved and extends in the left-right direction such that an upper end edge of the relief terminal portion 45 extending in the left-right direction rises in a plate thickness direction (more specifically, a front side). By providing the curved portion 46 in the relief terminal portion 45, as shown in FIG. 7, the work when the clip 53 is connected to the relief terminal portion 45 by clamping the upper end edge of the relief terminal portion 45 with a pair of clamping portions 54 of the clip 53 of the booster cable is facilitated. As described above, the input terminal 44 and the relief terminal portion 45 are commonly provided in the connection portion 41 having a continuous plate shape, which is a part of the bus bar 40 exposed from the housing 20.

The plurality of (four) output terminals 42 protrude downward from the lower end surface of the housing body 21 of the housing 20, and are arranged side by side in the left-right direction corresponding to the plurality of openings 24a. A terminal (not shown) provided at an end of an electric wire extending from a corresponding external load is connected to each output terminal 42.

The input terminal 47 protrudes downward from a lower end surface of the housing protruding portion 22 of the housing 20, and is disposed corresponding to the single opening 24b. A terminal (not shown) provided at an end of an electric wire extending from the DC/DC converter is connected to the input terminal 47.

The plurality of (four) fusing portions 43a are located inside the corresponding openings 24a. The fusing portions 43a are exposed to both the front side and the rear side through front and rear openings of the corresponding openings 24a, and are visible from both the front side and the rear side. Similarly, the single fusing portion 43b is located inside the single opening 24b. The fusing portion 43b is exposed to both the front side and the rear side through the front and rear openings of the opening 24b, and is visible from both the front side and the rear side. The low-melting body 50 is placed on one of front and rear surfaces (in this example, the front surface) of each fusing portion 43. A melting point of a material (for example, an alloy containing tin (Sn) as a main component) constituting the low-melting body 50 is lower than a melting point of a material (for example, an alloy containing copper (Cu) as a main component) constituting the bus bar 40 (the fusing portion 43).

As shown in FIG. 4, in the bus bar 40, the connection portion 41 (the input terminal 44 +the relief terminal portion 45) is connected to each of the plurality of output terminals 42 via one or both of the fusing portions 43a and the fusing portion 43b. In other words, the battery and the various kinds of external loads are electrically connected via one or both of the fusing portions 43a and the fusing portion 43b. Similarly, the input terminal 47 is connected to each of the plurality of output terminals 42 via one or both of the fusing portions 43a and the fusing portion 43b. In other words, the DC/DC converter and various kinds of external loads are electrically connected via one or both of the fusing portions 43a and the fusing portion 43b.

The bus bar 40 is designed such that the fusing portion 43 is fused using Joule heat when a current having a magnitude exceeding the rated current flows. When the fusing portion 43 is fused, the electrical connection between the output terminal 42 connected to the fused fusing portion 43 and the connection portion 41 (the input terminal 44+ the relief terminal portion 45) is disconnected.

The fusing principle of each fusing portion 43 is as follows. When a current having a magnitude exceeding the rated current flows through the fusing portion 43, a temperature of the fusing portion 43 reaches the melting point of the low-melting body 50 due to heat (Joule heat) generated in the fusing portion 43, so that the low-melting body 50 melts earlier than the fusing portion 43. When the melted (liquid-phase) low-melting body 50 comes into contact with the fusing portion 43, the metal material constituting the fusing portion 43 diffuses into the low-melting body 50 even if the fusing portion 43 itself has not yet reached the melting point. The fusing portion 43 is gradually eroded by this diffusion, and the fusing portion 43 is cut (fused). Based on the above-described fusing principle, the fusing portion 43 can be fused when the temperature of the fusing portion 43 at a location where the low-melting body 50 is placed reaches the melting point of the low-melting body 50 (even if the temperature does not reach a melting point of the fusing portion 43). Accordingly, the fuse element 10 is blown at a more practical temperature (a melting point of the low-melting body 50).

Next, the cover 30 will be described. The cover 30 is a molded body formed of a transparent resin material. The cover 30 has a function of covering and protecting the periphery of the fusing portion 43 so that the fusing portion 43 of the fuse element 10 can be visually recognized from an outside of the fusible link unit 1 in a state of being attached to the housing 20 (see FIG. 1).

As shown in FIG. 3, the cover 30 includes a pair of substantially rectangular flat plate-shaped side wall portions 31 extending in the upper-lower direction and the left-right direction and facing each other in the front-rear direction, and a coupling portion 32 coupling upper ends of the pair of front and rear side wall portions 31 to each other, and has a substantially U-shape that opens downward when viewed from the left-right direction. The pair of front and rear locking holes 33 are formed in central portions in the left-right direction of the upper ends of the pair of front and rear side wall portions 31 so as to correspond to the pair of front and rear locking projections 25 of the housing 20. The members constituting the fusible link unit 1 have been described above.

The cover 30 having the above configuration is attached to the housing body 21 of the housing 20. In order to attach the cover 30 to the housing body 21 of the housing 20, as shown in FIG. 3, the cover 30 is disposed on an upper side of the housing body 21, and the cover 30 is slid downward relative to the housing body 21 so that the pair of front and rear side wall portions 31 are respectively accommodated in the pair of front and rear cover accommodating recesses 23 of the housing body 21 and cover the plurality of (five) openings 24 from both front and rear sides. This sliding is continued until the pair of locking holes 33 of the cover 30 are engaged with the pair of locking projections 25 of the housing body 21.

When the pair of locking holes 33 are engaged with the pair of locking projections 25, the attachment of the cover 30 to the housing body 21 of the housing 20 is completed (see FIG. 1). In a state where the attachment of the cover 30 to the housing 20 is completed, the plurality of (five) openings 24 of the housing 20 are covered by the pair of side wall portions 31 from both front and rear sides. Accordingly, the plurality of fuse portions 43 are covered and protected by the cover 30 at positions away from the fuse portions 43 such that the fuse portions 43 can be visually recognized from an outside of the fusible link unit 1. The engagement between the pair of locking holes 33 and the pair of locking projections 25 prevents the cover 30 from moving upward relative to the housing 20 (that is, prevents the cover 30 from falling off).

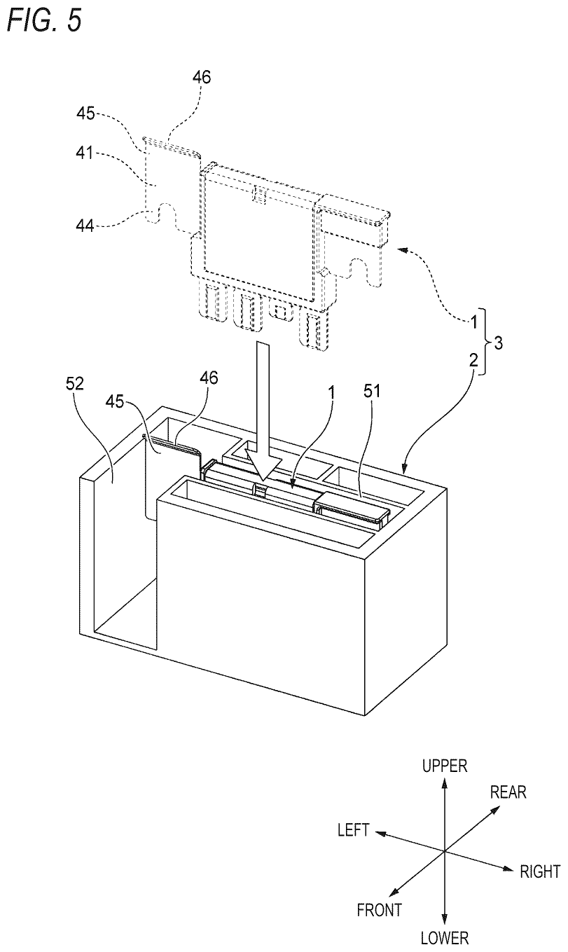

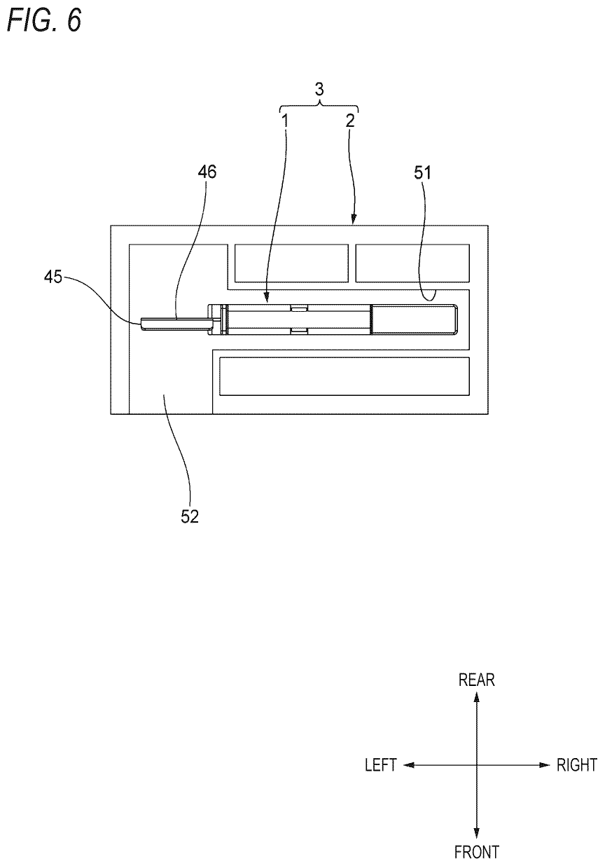

As shown in FIGS. 5 and 6, the fusible link unit 1 in a state where the attachment of the cover 30 to the housing 20 is completed is inserted from above and accommodated in accommodation spaces 51, 52 provided inside a substantially rectangular parallelepiped case 2, which is a housing of the electric junction box 3 (for example, a fuse box). The accommodation space 51 is a hole that penetrates in the upper-lower direction and extending in the left-right direction, and the accommodation space 51 accommodates a portion of the fusible link unit 1 (specifically, the entire housing 20 and the plurality of (five) output terminals 42 extending downward from the housing 20) excluding the connection portion 41 protruding leftward from the housing 20. The accommodation space 52 is a recessed portion (recess) that is located at a left peripheral edge of the case 2 and opens upward and forward, and the input terminal 44, which is a part of the connection portion 41 protruding leftward from the housing 20, is accommodated in the accommodation space 52. The relief terminal portion 45 (including the curved portion 46), which is a part of the connection portion 41, protrudes outside the accommodation space 52 (above an upper end of the case 2) (see FIGS. 5 and 7). Accordingly, it is easy to connect the clip 53 of the booster cable to the relief terminal portion 45.

As described above, in the electric junction box 3 in which the fusible link unit 1 is accommodated in the case 2, a part of the bus bar 40 is used as the relief terminal portion 45 to which the clip 53 of the booster cable can be connected. Therefore, it is not necessary to separately provide a dedicated bus bar or the like used as a relief terminal portion as in the related art. Further, the input terminal 44 for inputting electric power from the battery to the fusible link unit 1 is disposed at a left peripheral edge of the electric junction box 3. Therefore, the operability of the connection work between the input terminal 44 and the power cable extending from the battery is improved. Further, since the input terminal 44 is disposed in the left peripheral edge of the electric junction box 3, the relief terminal portion 45 commonly provided with the input terminal 44 in the plate-shaped connection portion 41, which is a part of the bus bar 40, is also disposed in the left peripheral edge of the electric junction box 3, and thus the operability of the user can be improved as compared with a case where the relief terminal portion 45 is disposed in the center or the like of the electric junction box 3. Further, the relief terminal portion 45 has a shape separated from the housing 20 in a direction (upward) opposite to a direction (downward) in which the output terminal 42 protrudes from the housing 20. Accordingly, when the fusible link unit 1 is fitted into the accommodation spaces 51, 52 of the electric junction box 3, the relief terminal portion 45 can easily protrude outside (an upper side) the accommodation space 52 of the electric junction box 3.

### Operations and Effects

As described above, according to the fusible link unit 1 of the present embodiment, a part of the bus bar 40 having a fuse function is used as the relief terminal portion 45 to which the relief tool (the clip 53 of the booster cable) can be connected. Therefore, when the fusible link unit 1 is attached to the electric junction box 3, it is not necessary to separately provide a dedicated bus bar or the like used as a relief terminal portion as in the related art. Further, the relief terminal portion 45 and the input terminal 44 are commonly provided on a continuous exposed piece (the connection portion 41) of the bus bar 40 exposed from the housing 20. The input terminal 44 for inputting electric power from a power source to the fusible link unit 1 is disposed in the peripheral edge of the electric junction box 3 in terms of the operability of connection work with a power cable. Therefore, when the fusible link unit 1 is attached to the electric junction box 3, the relief terminal portion 45 is also disposed on the peripheral edge of the electric junction box 3, and thus the operability of the user can be improved as compared with a case where the relief terminal portion 45 is located at the center or the like of the electric junction box 3. As described above, the fusible link unit 1 according to the present embodiment can reduce a size of the electric junction box 3.

Further, according to the fusible link unit 1 of the present embodiment, the relief terminal portion 45 includes the curved portion 46 that is curved such that a part of the peripheral edge of the exposed piece (the connection portion 41) of the bus bar 40 rises in the plate thickness direction. Accordingly, it is easy to connect a relief tool (the clip 53 of the booster cable) to the relief terminal portion 45.

Further, according to the fusible link unit 1 of the present embodiment, the relief terminal portion 45 has a shape separated from the housing 20 in a direction (upward) opposite to a direction (downward) in which the output terminal 42 protrudes. Accordingly, when the fusible link unit 1 is fitted into the accommodation spaces 51, 52 of the electric junction box 3, the relief terminal portion 45 can protrude outside the accommodation space 52 of the electric junction box 3. Therefore, the operability of the user can be improved.

Further, according to the electric junction box 3 of the present embodiment, the relief terminal portion 45, which is a part of the bus bar 40, is disposed to protrude outside the accommodation space 52 of the case 2. Accordingly, the operability of the user can be improved.

### Other Embodiments

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, dimensions, numbers, arrangement locations, and the like of the respective constituent elements in the above embodiment are optionally selected and are not limited as long as the present disclosure can be implemented.

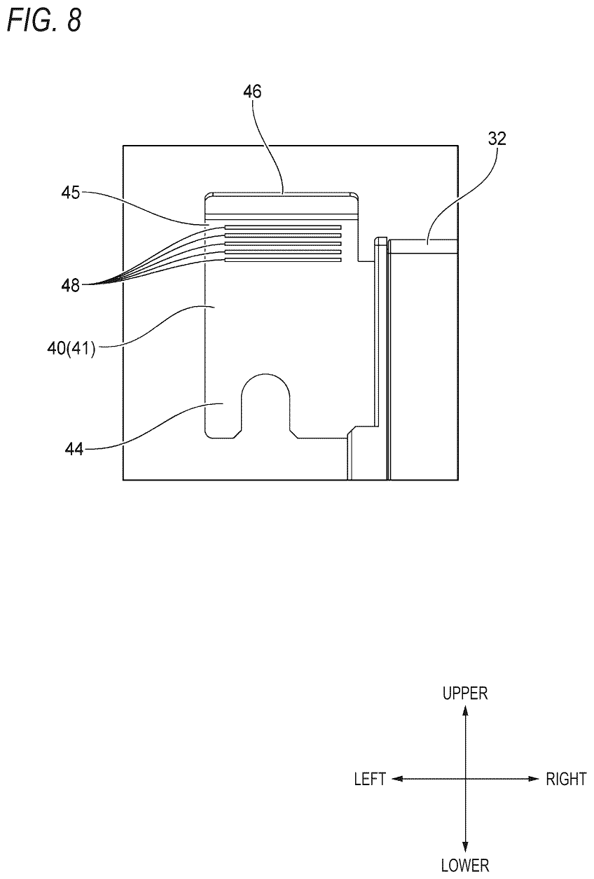

For example, in the above embodiments, an upper region of the exposed piece (the connection portion 41) of the bus bar 40 is used as the relief terminal portion 45. Here, as shown in FIG. 8, one or a plurality of recesses 48 (so-called serrations) may be provided in the upper region of the connection portion 41, that is, in the vicinity of the curved portion 46. By providing such a recess 48, the user can easily visually recognize the relief terminal portion 45, and the clip 53 of the booster cable can be firmly fixed to the relief terminal portion 45. The recess 48 also has a function of visually indicating that the relief terminal portion 45 is provided at a position different from a normal energization path from the input terminal 44 to the output terminal 42.

Here, the characteristics of the embodiments of the fusible link unit 1 and the electric junction box 3 according to the present disclosure described above will be briefly summarized and listed in the following [1] to [5].
[1] A fusible link unit (1) including:
a conductor (40) having a fuse function; and
a housing (20) that accommodates the conductor (40), in which the conductor (40) includes
   an input terminal (44) that inputs electric power from a power source,
   an output terminal (42) that outputs the electric power,
   a fusing portion (43) disposed on an energization path from the input terminal (44) to the output terminal (42), and
   a relief terminal portion (45) capable of connecting a relief tool (53) for supplying the electric power to the power source from outside, and
the input terminal (44) and the relief terminal portion (45) are provided on a continuous exposed piece (41) of the conductor (40) exposed from the housing (20).

According to the fusible link unit having the configuration of the above [1], a part of the conductor (for example, a bus bar) having a fuse function is used as a relief terminal portion to which a relief tool can be connected. In other words, the fusible link unit has a function as a relief terminal in addition to its original overcurrent interruption function. Therefore, it is not necessary to provide a dedicated bus bar or the like used as a relief terminal portion in an electric junction box. Therefore, in the fusible link unit of the present disclosure, it is possible to reduce the size of the electric junction box while providing the relief terminal in the electric junction box.

Furthermore, as another effect, in the fusible link unit having the present configuration, the relief terminal portion and the input terminal are commonly provided on a continuous exposed piece of the conductor exposed from the housing. In general, an input terminal that inputs electric power from a power source such as an in-vehicle battery to the fusible link unit is disposed at a peripheral edge of the electric junction box in terms of the operability of work of connecting a power cable. Therefore, when the fusible link unit is attached to the electric junction box, the relief terminal portion is also disposed on the peripheral edge of the electric junction box. Therefore, as compared with a case where the relief terminal portion is disposed at the center of the electric junction box or the like, the operability of a user when a relief operation is actually performed can be improved.

[2] The fusible link unit (1) according to [1], in which
the exposed piece (41) of the conductor (40) has a plate shape, and
the relief terminal portion (45) has a curved portion (46) that is curved such that a part of a peripheral edge of the exposed piece (41) rises in a plate thickness direction.

According to the fusible link unit having a configuration of the above [2], the relief terminal portion has the curved portion that is curved such that a part of the peripheral edge of the exposed piece of the conductor rises in the plate thickness direction. Accordingly, it is easy to connect a relief tool (for example, a clip of a booster cable) to the relief terminal portion.

[3] The fusible link unit (1) according to [1], in which
the output terminal (42) has a shape protruding from the housing (20) in a predetermined direction, and
the relief terminal portion (45) has a shape separated from the housing (20) in a direction opposite to the predetermined direction.

According to the fusible link unit having the configuration of the above [3], the relief terminal portion has a shape separated from the housing in a direction opposite to a direction in which the output terminal protrudes. Accordingly, for example, when the fusible link unit is fitted into the accommodation space of the electric junction box, the relief terminal portion can protrude outside the accommodation space of the electric junction box. Therefore, the operability of the user when a relief operation is performed can be improved.

[4] An electric junction box (3) including:
the fusible link unit (1) according to any one of [1] to [3]; and
a case (2) having an accommodation space (51, 52) in which the fusible link unit (1) is accommodated.

According to the electric junction box having the configuration of the above [4], a part of the conductor (for example, a bus bar) having a fuse function of the fusible link unit is used as a relief terminal portion to which a relief tool can be connected. In other words, the fusible link unit has a function as a relief terminal in addition to its original overcurrent interruption function. Therefore, it is not necessary to provide a dedicated bus bar or the like used as the relief terminal portion in the electric junction box. Therefore, in the fusible link unit of the present disclosure, it is possible to reduce the size of the electric junction box while providing the relief terminal in the electric junction box.

Furthermore, as another effect, in the electric junction box having the present configuration, the relief terminal portion and the input terminal of the fusible link unit are commonly provided on a continuous exposed piece of the conductor exposed from the housing. In general, an input terminal that inputs electric power from a power source such as an in-vehicle battery to the fusible link unit is disposed at a peripheral edge of the electric junction box in terms of the operability of work of connecting a power cable. Therefore, when the fusible link unit is attached to the electric junction box, the relief terminal portion is also disposed on the peripheral edge of the electric junction box. Therefore, as compared with a case where the relief terminal portion is disposed at the center of the electric junction box or the like, the operability of the user when the relief operation is actually performed can be improved.

[5] The electric junction box (3) according to [4], in which
the fusible link unit (1) is disposed such that at least a part of the relief terminal portion (45) of the conductor (40) protrudes outside the accommodation space (52).

According to the electric junction box having a configuration of the above [5], the relief terminal portion of the conductor is disposed to protrude outside the accommodation space of the case. Accordingly, the operability of the user when the relief operation is performed can be improved.

What is claimed is:

1. A fusible link unit comprising:
a conductor having a fuse function; and
a housing that accommodates the conductor, wherein
the conductor includes
an input terminal that inputs electric power from a power source,
an output terminal that outputs the electric power,
a fusing portion disposed on an energization path from the input terminal to the output terminal, and
a relief terminal portion capable of connecting a relief tool for supplying the electric power to the power source from outside, and
the input terminal and the relief terminal portion are provided on a continuous exposed piece of the conductor exposed from the housing.

2. The fusible link unit according to claim 1, wherein
the exposed piece of the conductor has a plate shape, and
the relief terminal portion has a curved portion that is curved such that a part of a peripheral edge of the exposed piece rises in a plate thickness direction.

3. The fusible link unit according to claim 1, wherein
the output terminal has a shape protruding from the housing in a predetermined direction, and
the relief terminal portion has a shape separated from the housing in a direction opposite to the predetermined direction.

4. An electric junction box comprising:
the fusible link unit according to claim 1; and
a case having an accommodation space in which the fusible link unit is accommodated.

5. The electric junction box according to claim 4, wherein
the fusible link unit is disposed such that at least a part of the relief terminal portion of the conductor protrudes outside the accommodation space.
